(19) United States
(12) Patent Application Publication
(10) Pub. No.: US 2010/0330421 A1
(43) Pub. Date: Dec. 30, 2010

(54) CORE-SHELL HIGH CAPACITY NANOWIRES FOR BATTERY ELECTRODES

(76) Inventors: Yi Cui, Sunnyvale, CA (US); Song Han, Foster City, CA (US); Ghyrn E. Loveness, Menlo Park, CA (US)

Correspondence Address: Weaver Austin Villeneuve & Sampson LLP, P.O. BOX 70250, OAKLAND, CA, 94612-0250, US

(21) Appl. No.: 12/787,168

(22) Filed: May 25, 2010

Related U.S. Application Data
(60) Provisional application No. 61/181,637, filed on May 27, 2009.

(51) Int. Cl. H01M 4/583; H01M 4/02; H01M 4/58; H01M 4/62; B05D 5/12; B32B 37/14

(52) U.S. Cl. 429/217; 429/209; 429/218.1; 429/231.8; 427/77; 156/294; 977/742; 977/948

(57) ABSTRACT

Provided are nanostructures containing electrochemically active materials, battery electrodes containing these nanostructures for use in electrochemical batteries, such as lithium ion batteries, and methods of forming the nanostructures and battery electrodes. The nanostructures include conductive cores, inner shells containing active materials, and outer shells partially coating the inner shells. The high capacity active materials having a stable capacity of at least about 1000 mAh/g can be used. Some examples include silicon, tin, and/or germanium. The outer shells may be configured to substantially prevent formation of Solid Electrolyte lnterphase (SEI) layers directly on the inner shells. The conductive cores and/or outer shells may include carbon containing materials. The nanostructures are used to form battery electrodes, in which the nanostructures that are in electronic communication with conductive substrates of the electrodes.

### CROSS-REFERENCE TO RELATED APPLICATIONS

This application claims the benefit of U.S. Provisional Application No. 61/181,637, filed May 27, 2009, entitled “Core-Shell High Capacity Nanowires for Battery Electrodes,” which is incorporated herein by reference in its entirety for all purposes.

### TECHNICAL FIELD

The present invention relates generally to electrochemical cell components and methods of preparing such components and, more specifically, to battery electrodes containing core-shell high capacity nanowires for interacting with electrochemically active ions and methods of preparing such electrodes and batteries.

### BACKGROUND OF THE INVENTION

There is a demand for high capacity rechargeable batteries. Many applications, such as aerospace, medical devices, portable electronics, automotive and others, require high gravimetric and/or volumetric capacity batteries. Developments in lithium ion technology provided some advances in this area, but higher capacities are still desirable. Lithium ion cells generally include anodes containing graphite powder that has theoretical capacity of only about 372 mAh/g.

Silicon is an attractive insertion material for lithium and other electrochemically active ions. A theoretical capacity of silicon in lithium ion cells is about 4200 mAh/g. Yet use of silicon and many other high capacity materials for battery applications has been constrained by substantial changes in volume (swelling and contraction) of these materials during insertion and removal of active ions. For example, silicon swells as much as 400% during lithiation. Volume changes of this magnitude cause pulverization of the active material, loss of electrical connections within the electrode, and capacity fading of the battery. Further, many high capacity materials, e.g., silicon, have poor electrical conductivity and often require special design features or conductive additives that may negatively impact battery capacity. Overall, there is a need for improved application of high capacity active materials in battery electrodes that minimize the drawbacks described above.

### SUMMARY

Provided are nanostructures containing electrochemically active materials, battery electrodes containing these nanostructures for use in electrochemical batteries, such as lithium ion batteries, and methods of forming the nanostructures and battery electrodes. The nanostructures include conductive cores, inner shells containing active materials, and outer shells partially coating the inner shells. The high capacity active materials having a stable capacity of at least about 1000 mAh/g can be used. Some examples include silicon, tin, and/or germanium. The outer shells may be configured to substantially prevent formation of Solid Electrolyte Interphase (SEI) layers directly on the inner shells. The conductive cores and/or outer shells may include carbon containing materials. The nanostructures are used to form battery electrodes, in which the nanostructures that are in electronic communication with conductive substrates of the electrodes.

In certain embodiments, a nanostructure for use in a battery electrode includes a conductive core for providing electronic conductivity along the length of the nanostructure, an inner shell including a high capacity electrochemically active material, and an outer shell partially coating the inner shell and substantially preventing formation of a Solid Electrolyte Interphase (SEI) layer directly on the inner shell. At least the inner shell is in electronic communication with the conductive core. In certain embodiments, at least about 10% of an inner shell is not coated with the outer shell. In certain embodiments, a nanostructure has a branched structure. Nanostructures may also have a third shell disposed between their inner shells and outer shells.

In certain embodiments, an active material has a stable electrochemical capacity of at least about 1000 mAh/g. Active materials may include silicon, germanium, and tin. The active material may include one or more dopants. In the same or other embodiments, the active material includes amorphous silicon, while a conductive core and/or outer shell includes carbon. An outer shell may include graphite, graphene, graphite oxide, and/or metal oxide. In certain embodiments, a conductive core includes a carbon containing material with a carbon content of at least about 50%. In the same or other embodiments, an inner shell provides at least about 50% of the overall electrochemical capacity of the nanostructure.

In certain embodiments, a nanostructure is formed as a nanowire having a length of at least about 1 millimeter. A nanostructure may have a diameter of no greater than about 500 nanometers. In certain embodiments, a nanostructure is a nanoparticle. In the same or other embodiments, a nanostructure has a outer shell having a thickness of between about 1 nanometer and 100 nanometers. In certain embodiments, a conductive core is hollow. For example, a conductive core may include a carbon single wall nanotube (SWNT) and/or a carbon multi-wall nanotube (MWNT). In certain embodiments, an average ratio of a void region of nanostructures to a solid region is between about 0.01 and 10.

In certain embodiments, a battery electrode for use in an electrochemical battery includes a conductive substrate and a nanostructure. Various features of nanostructures that can be used for battery electrodes are described above. For example, nanostructures may have a conductive core for providing electronic conductivity along the length of the nanostructure, an inner shell including a high capacity electrochemically active material and being in electronic communication with the conductive core, and an outer shell partially coating the inner shell. The inner shell may be configured to substantially prevent formation of a Solid Electrolyte Interphase (SEI) directly on the inner shell. The active material may have a capacity of at least about 1000 mAh/g. At least a conductive core and inner shell may be in electronic communication with a conductive substrate.

In certain embodiments, a conductive core, inner shell, and/or outer shell of a nanostructure form a direct bond with a conductive substrate. For example, a direct bond may include a silicide. In certain embodiments, an outer shell includes a carbon layer that extends over at least a portion of the nanostructure-facing surface of the conductive substrate and forms a direct bond between the nanostructure and the conductive substrate. In some embodiments, a battery electrode contains an elastomeric binder.

In certain embodiments, a method of forming a nanostructure for use in a battery electrode includes forming a conductive core for providing electronic conductivity along the length of the nanostructure, forming an inner shell including a high capacity electrochemically active material, and forming an outer shell partially coating the inner shell. The inner shell may be in electronic communication with the conductive core. The active material may have a stable electrochemical capacity of at least about 1000 mAh/g. The outer shell may be configured to substantially prevent formation of a Solid Electrolyte Interphase (SEI) directly on the inner shell. In certain embodiments, a conductive core is formed by electrospinning.

In certain embodiments, an outer shell is formed after placing a partially fabricated nanostructure including a conductive core and inner shell in contact with a conductive substrate. The outer shell may establish a bond between the nanostructure and the conductive substrate. In certain embodiments, the method may include an operation for bonding a nanostructure to a conductive substrate. For example, bonding may include heating a nanostructure and conductive substrate to a predetermined temperature and applying a predetermined pressure between the nanostructure and conductive substrate. In certain embodiments, the predetermined temperature is between about 300° C. and 500° C. Bonding may include forming a silicide on a nanostructure and pressing the nanostructure containing the silicide against the conductive substrate to form chemical bonds between the silicide and the conductive substrate.

These and other aspects of the invention are described further below with reference to the figures.

### BRIEF DESCRIPTION OF THE DRAWINGS

FIGS. 1A-B illustrate a side view and a top view of a nanostructure including a core and multiple shells in accordance with certain embodiments.

FIGS. 2A-C illustrate various electrode configurations including nanostructures in accordance with certain embodiments.

FIG. 3 illustrates a process flow chart for manufacturing nanostructures in accordance with certain embodiments.

FIG. 4 is a schematic representation of a nanostructure illustrating cross-sectional profiles of a hollow core and shell of the nanostructure in accordance with certain embodiments.

FIGS. 5A-B are top and side schematic views of an illustrative electrode arrangement in accordance with certain embodiments.

FIGS. 6A-B are top and perspective schematic views of an illustrative round wound cell in accordance with certain embodiments.

FIG. 7 is a top schematic view of an illustrative prismatic wound cell in accordance with certain embodiments.

FIGS. 8A-B are top and perspective schematic views of an illustrative stack of electrodes and separator sheets in accordance with certain embodiments.

FIG. 9 is a schematic cross-section view of an example of a wound cell in accordance with embodiments.

### DETAILED DESCRIPTION OF EXAMPLE EMBODIMENTS

In the following description, numerous specific details are set forth in order to provide a thorough understanding of the present invention. The present invention may be practiced without some or all of these specific details. In other instances, well known process operations have not been described in detail to avoid obscuring the present invention. While the invention will be described in conjunction with the specific embodiments, it will be understood that it is not intended to limit the invention to the embodiments.

### Introduction

Carbon is a common anode active material with a good electronic conductivity but relatively low capacity in ion insertion batteries. Carbon is typically used in a powder form (e.g., graphite micron-size particles) and requires a binder for mechanical attachment to a conductive substrate. Silicon is an attractive insertion material from the capacity standpoint, but it has poor cycle life performance due to pulverization and has low conductivity.

Certain disclosed embodiments involve an inventive combination of carbon and silicon in an electrode. Techniques are disclosed for promoting and maintaining contact between carbon and silicon during silicon's volume change during cycling. Further techniques are disclosed for utilizing carbon's high conductivity and desirable Solid Electrolyte Interphase (SEI) layer formed on the negative electrode during formation cycles.

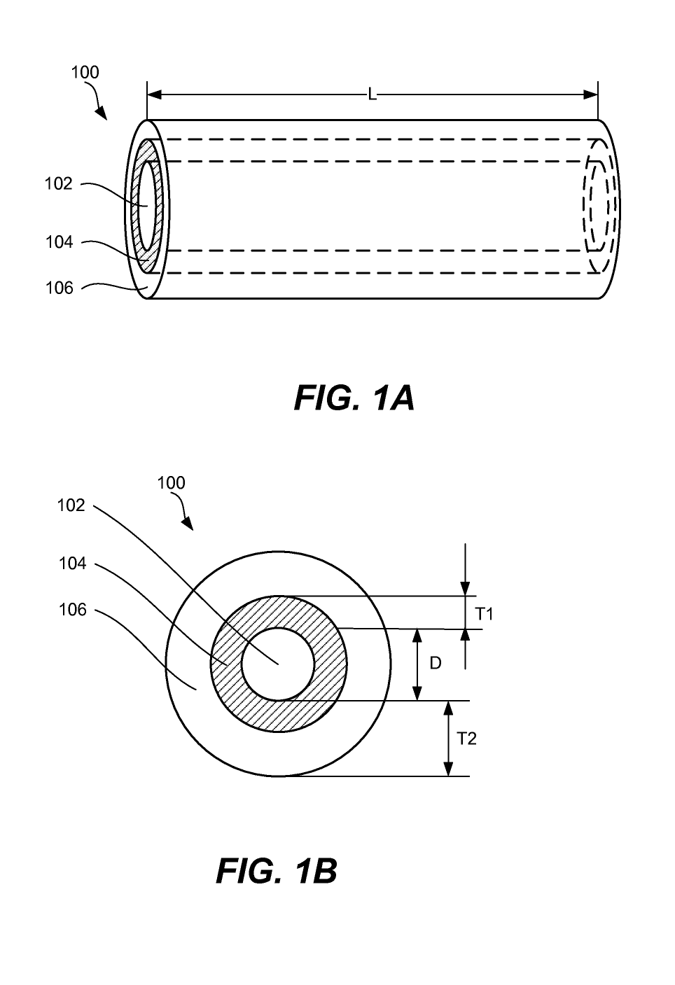

It has been unexpectedly found that certain nanostructures where silicon or other high capacity insertion material (a “shell”) is supported by a core (which may be highly conductive in certain embodiments) and at least partially coated from an electrolyte but not from an electro-active ions by an outer layer (another shell) helps to overcome certain problems indicated above. An example of such nanostructures is presented in FIGS. 1A-B. The nanostructure 100 may be formed around a core 102, which may be a solid or hollow structure itself. The core may include a conductive material (e.g., carbon, metal) that in some embodiments provides mechanical support to other components of the nanostructure 100. The nanostructure 100 may include two or more shells 104 and 106 fully or partially surrounding the core 102. Generally, at least one of the internal shells includes a high capacity active material, such as silicon, germanium, and tin. Another outer shell can mitigate certain undesirable properties of these high capacity materials including excessive swelling, poor electronic conductivity, poor SEI layer formation, and others.

### Core-Shell Structure

FIG. 1A illustrates a side view of a nanostructure 100 in accordance with certain embodiments. The nanostructure 100 includes a core 102, one inner shell 102, and one outer shell 106. It should be understood that nanostructures may have any practical number of inner shells (e.g., between about 1 and 50 or, in more specific embodiments, between about 1 and 10), which is usually driven by required functionalities, such as electrical connections, mechanical support, improving capacity, and SEI layer functions. For clarity, the description below is directed to the nanostructure 100 with one inner shell 104. However, it should be understood that this description is applicable to other configurations as well.

The longest dimension of the nanostructure 100 is referred to as a principal dimension (L). Generally, though not necessarily, the core 102 and the shells 104 and 106 extend through the entire principal dimensions; in other words the core and all shells share a substantially common axis, which is the principal dimension. In certain embodiments, one or more shells may be shorter than the principal dimension of the nanostructure 100. For example, an outer shell may extend less than about 90%, less than about 75%, or less than about 50% of the principal dimension. Further, a shell may completely cover a core or a corresponding inner shell (collectively referred to as an inner layer) up to the point the shell extends to. Alternatively, a shell may partially cover an inner layer leaving certain areas of the inner layer exposed. For example, a shell may expose at least about 10% of the inner layer area, at least about 50%, or at least about 90%. A shell may form discreet or interconnected patches over the inner layer.

FIG. 1B illustrates a cross-section (or a top view) of the nanostructure 100. Cross-sectional shapes of nanostructures and each individual components generally depend on compositions, crystallographic structures (e.g., crystalline, amorphous), sizes, deposition process parameters, and other factors. Shapes may also change during cycling. Irregularities of cross-sectional shapes require a special dimensional characterization. For the purposes of this application, a cross-section dimension is defined as a distance between the two most separated points on a periphery of a cross-section that is transverse to the principal dimension, such as length. For example, a cross-section dimension of a cylindrical nano-rod circle is the diameter of the circular cross-section.

In one embodiment, a core-shell structure forms nested or concentric layers over a rod or wire, where one layer is surrounded by another outer layer, e.g., forming a set of concentric cylinders similar to the structure shown in FIG. 1B. In other embodiments (not shown), each layer of the nanostructure is a sheet that is rolled around itself and other layers to form a spiral. For simplicity, both of these embodiments are referred to as a core-shell structure.

Note that in the concentric core-shell embodiments, not all shell layers need to be fully concentric with the core and/or other shell layers. For example, one or more of the shells may not cover the full angular extent of core circumference. Such gaps may extend fully or partially along the length of the principal dimension. Further, in certain embodiments, the core shell structures may assume a non-rod/wire shape. Examples include particles (including spheres, ellipsoids, etc.), pyramids rooted to a substrate, spider structures having multiple rods and/or particles extending from a common connection point or region, and the like. Further, the rods or other structures may have a non-linear shape, which includes shapes where the axial position bends or even assumes a tortuous path. Various examples of nanostructure shapes and sizes are presented in U.S. patent application Ser. No. 12/437,529, filed May 7, 2009, which is incorporated herein by reference.

It should be noted that many dimensions described below would change during electrochemical cycling of the electrodes containing nanostructures. Therefore, all dimensions are provided for newly deposited nanostructures before the initial cycling. It should be also noted that in certain embodiments, pre-lithiation (e.g., pre-loading a nanostructure with lithium during or immediately after the deposition of the structure) is considered to be a part of the deposition process and, therefore, would be considered in the dimension descriptions presented below.

In certain embodiments, an average cross-section dimension of the core is between about 5 nanometers and 500 nanometers or, in more specific embodiments, between about 10 nanometers and 100 nanometers. This dimension will generally depend on the core materials (e.g., conductivity, compressibility), thickness of the inner layer containing silicon, and other parameters. For example, high rate battery applications may require a larger core to reduce an overall resistance of the nanostructures. Generally, a cross-section dimension of the core (and thicknesses of shells further described below) does not substantially vary along the length of the nanostructure. However, in certain embodiments, the core (and possibly a resulting nanostructure) may be tapered or have a have variable cross-section dimension along the length.

In the same or other embodiments, an average length (L) (or principal dimension) of the core is between about 1 micrometer and 100 centimeters or, in certain more specific examples, between about 1 micrometer and 10 millimeters, or even more specifically, between about 1 micrometer and 100 microns. Other ranges may include: between about 1 micrometer and 10 centimeters, between about 1 micrometer and 1 centimeter, between about 1 micrometer and 100 millimeters. The average length may be determined by the length of the core. The length of branched (tree-like) nanostructures is an average length of all branches. Further, nanostructures interconnected in a mesh-like structure (e.g., carbon fiber paper) are generally described in terms of an average opening size, which could be between about 10 nanometers and 10 millimeters or, in more specific embodiments, between about 100 nanometers and 1 millimeter. An average length of nanostructures is generally driven by electrical conductivity and mechanical support considerations. For example, longer nanowires may form an interconnected network which may be provided in an electrode without a need for a conductive substrate.

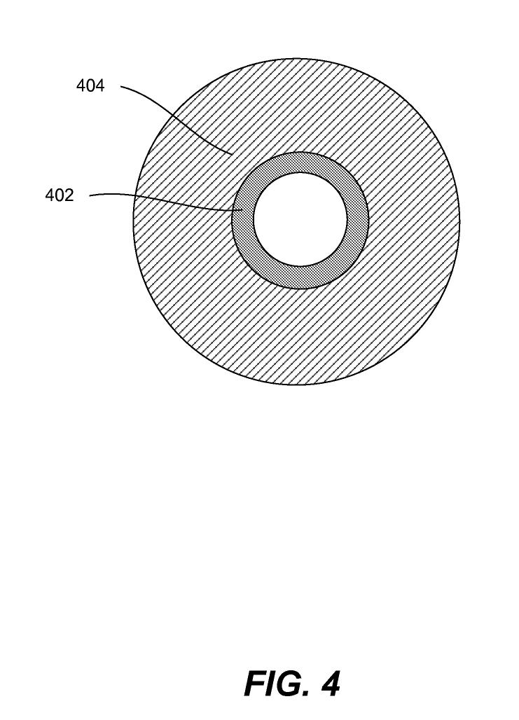

In certain embodiments, the core 102 is solid. For example, a core may be a fiber (carbon, metal), a rod, a wire, or any other like shape. In other embodiments, a core may be a hollow (e.g., tube-like) structure as, for examples, shown in FIG. 4, which illustrates a hollow core 402 and a shell formed around the core. A hollow core may be formed from an initially solid core. For example, a solid core may be shrunk or partially removed to form a hollow core. In another embodiment, a hollow core may be formed by depositing core materials around a template that is later removed. In certain embodiments, a carbon single wall nanotube (SWNT) or a multi-wall nanotube (MWNT) may serve as a core. The cross-sectional profile of these hollow nanostructures includes void regions surrounded by annular solid regions. An average ratio of the void regions to the solid regions may be between about 0.01 and 100, more specifically between about 0.01 and 10. The cross-section dimension of the hollow nanostructures may be substantially constant along the principal dimension (e.g., typically the axis). Alternatively, the hollow nanostructures may be tapered along the principal dimension. In certain embodiments, multiple hollow nanostructures may form a core-shell arrangement similar to multiwall nanotubes.

As, mentioned, at least one inner shell typically includes a high capacity material of a type further described below. However, a core and other shells may also contribute to an overall capacity of the nanostructure. In certain embodiments, selection of materials and dimensions for each component of a nanostructure is such that one or more inner shells containing high capacity materials provide at least about 50% of the overall nanostructure capacity or, in more specific embodiments, at least about 75% or at least about 90%.

The amount of material in the inner shell is determined by an average (T1) thickness of this shell as shown in FIG. 1B. This thickness may be selected such that the high active material (e.g., silicon) stays below its fracture stress level during insertion and removal of electro-active ions. Generally, an average inner shell thickness depends on crystallographic structures of high capacity material (e.g., crystalline or amorphous), an average cross-section dimension (D) of the core 102, materials used for the core 102 and the outer shell 106, materials sued for the inner shell (e.g., dopants), capacity and rate requirements, and other factors. The average thickness may be between about 5 nanometers and 500 nanometers or, in more specific embodiments between about 10 nanometers and 100 nanometers.

The outer shell 106 may be designed to coat the inner shell 104 and protect the inner shell 104 from contacting an electrolyte (and forming a detrimental SEI layer), to allow electro-active ions to pass to and from the core, to improve electrical contacts among nanostructures in the active layer, to establish mechanical and/or electrical connection to the conductive substrate, if one is used, and/or other purposes. The thickness (T2) of the outer shell 106 may be selected to provide one or more functions listed above. In certain embodiments, the thickness of the outer shell is between about 1 nanometer and 100 nanometers or, in more specific embodiments between about 2 nanometers and 50 nanometers.

### Core-Shell Materials

The core 102 may serve one or more functions, such as provide mechanical support for other elements, provide electronic conductivity, provide insertion points for electro-active ions, and other functions. Materials for the core may be selected to achieve these functions and allow further processing (e.g., depositing shells, constructing an electrode and an electrochemical cell). Several materials, such as carbon fibers, carbon meshes, carbon fabrics, carbon papers, single wall carbon nanotubes, multi-wall carbon nanotubes, crystalline silicon nanowires, zinc oxide nanowires, tin oxide nanowires, indium oxide nanowires, metal fibers, carbon fibers coated with metal, and like, have recently became available and acceptable for battery manufacturing.

In certain embodiments, the core 102 includes carbon. The carbon content of the core may be at least about 50% or, in more specific embodiments, at least about 90% or at least about 99%. Other materials that may be used to make the core are silicon, germanium, tin, aluminum, lithium, titanium, and oxides and nitrides of the listed materials. Further, various dopants described below may be used in combination with one or more materials listed above.

One of the main functions of the inner shell is to provide insertion sites for electro-active ions. Therefore, materials with high electrochemical capacity (also referred to as high capacity materials) are generally selected for the inner shell. In certain embodiments, the inner shell 104 includes silicon. The silicon content in the inner shell may be at least about 50% or, in more specific embodiments, at least about 90% or at least about 99%. Silicon may have an amorphous structure (a-Si), crystalline structure (c-Si), or combination of amorphous and crystalline structures (a/c-Si). It should be noted that some silicon may undergo structural changes during cycling. Therefore, the following values are provided for a newly deposited inner layer that has not been subjected to cycling. In certain embodiments, the ratio of a-Si to c-Si in the inner shell is between about 0 to 100 or, in more specific embodiments, between about 0.1 and 10. In some embodiments, this ratio is between about 0 and 1. In other embodiments, the inner shell is predominantly a-Si.

In certain embodiments, the inner shell includes, germanium, tin, aluminum, titanium, carbon, as well as oxide and nitrides of the above mentioned materials (e.g., silicon oxide, tin oxide, titanium oxide), and other materials. These materials may be combined with silicon and/or carbon in the inner shell.

In the same or other embodiments, the inner shell includes one or more dopants, e.g., elements from the groups III and V of the periodic table. For example, silicon containing nanostructures can be doped with one or more elements from the group consisting of boron, aluminum, gallium, indium, thallium, phosphorous, arsenic, antimony, and bismuth. It has also been found that certain conductivity enhancement components improve charge transfer properties of the active layer. Other dopant atoms besides group III or V atoms may be employed. Examples include sulfur, selenium, etc. Doped silicon has higher electron or hole density in comparison with un-doped silicon (e.g., the Fermi level shifts closer to or even into the conduction or valence band, resulting in higher conductivity). In certain embodiments, one or more dopants have concentration of between about 10¹⁴ and 10¹⁹ atoms per centimeter cubed. In other embodiments, one or more dopants have concentration of between about 10¹⁹ and 10²¹ atoms per centimeter cubed. In yet another embodiment, concentration is between about 10²¹ and 10²³ atoms per centimeter cubed. Dopants may be introduced into the inner shell during formation of the shell (e.g., one or more silicon containing precursor gases may be introduced together with one or more dopant containing gases during CVD deposition), using spin-on coating, ion implantation, etc.

The outer shell may generally include materials that help to improve conductivity among nanostructures in the active layer of the electrode, establish mechanical and/or electrical connection to the substrate if one is used, prevent formation of an undesirable SEI layer, allow penetration of active ions to and from the inner shell, and perform other functions. In certain embodiments, the outer shell may include carbon. The carbon content of the outer shell may be at least about 50% or, in more specific embodiments, at least about 90% or at least about 99%. In certain specific embodiments, the outer shell may include graphite, graphene, graphene oxide, metal oxide (e.g., titanium oxide) and or other materials.

Electrodes including Core-Shell Structures

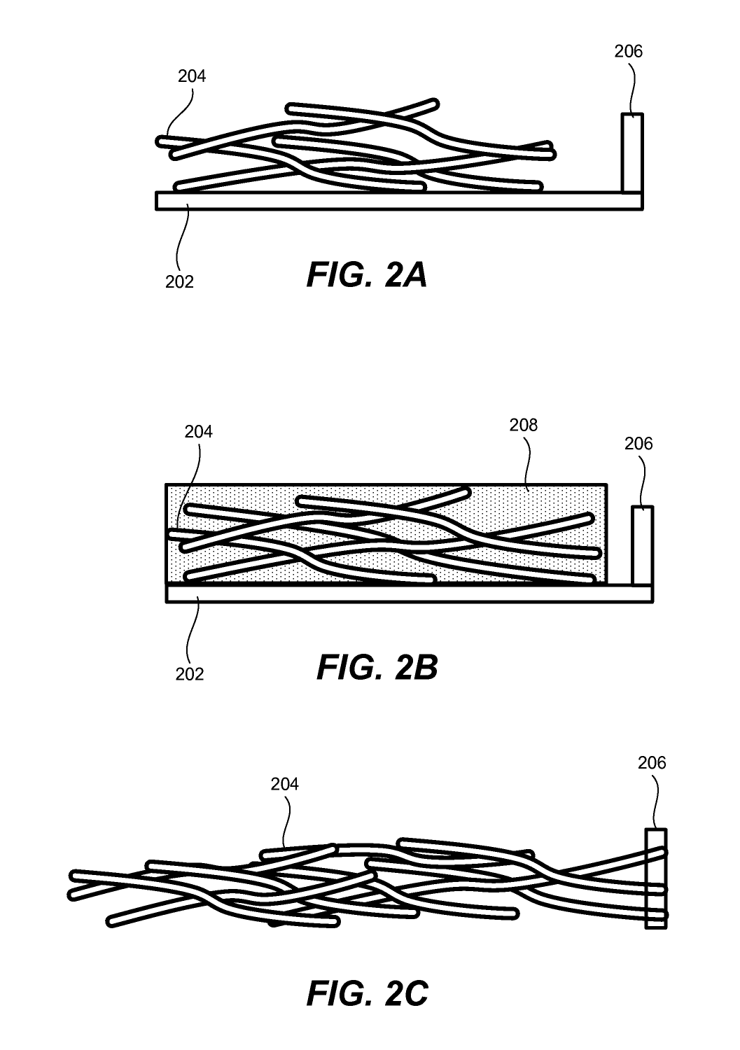

Various electrode configurations that include nanostructures described above may be implemented. In certain embodiments, electrodes include a conductive substrate 202 as shown in FIGS. 2A and 2B. The conductive substrate 202 may be used both to support the nanostructures 204 and provide an electronic pathway between a part of the battery terminal 206 (e.g. a flexible tab connecting the substrate 202 to the terminal) and the nanostructure 204. A substrate may be relatively flat or planar (e.g., a foil or plate with a thickness of between about 1 micrometer and 50 micrometers) or substantially non-planar (e.g., spheres, cones, arcs, saddles, and the like). In certain examples, a substrate may be a mesh, perforated sheet, foam, felt, and the like. Typically, though not necessarily, the substrate will be conductive, having a conductivity of at least about 10³ S/m, or more specifically at least about 10⁶ S/m or even at least about 10⁷ S/m. Examples of suitable substrate materials include copper, titanium, aluminum, stainless steel, doped silicon, and other materials.

In certain embodiments, nanostructures may be interconnected with a substrate without an elastomeric binder. One example of these embodiments is shown in FIG. 2A. Substrate and outer shell materials may be carefully selected to ensure bonding. For example, certain metal substrates (e.g., copper, stainless steel) form a bond with carbon, such as is present in the outer shell of the nanostructures, when certain heat and pressure is applied between the two. In the same or other embodiments, the bonding may be further enhanced by introducing and then fusing certain foreign materials (e.g., metal particles) into the active material structure.

For example, nanostructures may be annealed to each other and/or a substrate using high temperature (200-700° C.) and, in certain examples, pressure such that the nanostructures form multiple bonds to (e.g., they “fuse” with) each other and/or the substrate. This provides both mechanical and electrical interconnections. It may take between about 10-60 minutes at the above mentioned temperatures to create a bond between a metallic substrate (e.g., copper or stainless steel) and a carbon portion of the nanostructures. It should be noted that the bonding may be formed with a core, inner shell, or outer shell. For example, a carbon core may be bonded to the substrate before depositing the inner and outer shells.

In certain embodiments, the nanostructures are annealed to the substrate using a combination of high temperature and pressure. For example, nanostructures having exposed silicon (e.g., in the inner shell) or carbon (e.g., in the outer shell or core) portion may be pressed against the substrate (e.g., copper or stainless steel). A pressure may be between about 1 and 100 atmosphere (more specifically between about 1 and 10 atmospheres) and a temperature may be between about 200° C. and 700° C. (more specifically between about 300° C. and 500° C.). A vacuum or inert gas environment may be used in order to prevent oxidation of the electrode components. The process may take between about 15 minutes and 2 hours to form sufficient bonds within the active layer and between the active layer and the substrate.

In certain embodiments, a carbon core and a silicon inner shell may be processed to form silicides that are reactive with metallic substrates. Once the silicides are formed, the partially formed nanostructures may be pressed against the substrate (e.g., 0.5-5 atmospheres) and the entire stack is heated to form chemical bonds among the nanostructures and the nanostructures and substrate.

In other embodiments, the nanostructures can be mixed with a polymer binder (e.g., PVDF, CMC) and conductive additives (e.g., Carbon Black, Super P) and coated onto the substrate. An example is illustrated in FIG. 2B showing a binder 208 that attached the nanostructures 204 to the substrate coating For smaller nanowires, a doctor blade coating may be suitable, while longer nanowires may require special techniques (e.g., extrusion, lamination).

Certain configurations of electrodes may not require a substrate. Mechanical support and electronic pathways are provided by nanostructures or, more specifically, by the network of the nanostructures. One such example shown in FIG. 2C. The nanowires 204 are interconnected and one or more side of this network are directly attached to a part of the battery terminal 206. The network may be provided by carbon fiber paper (e.g., one formed from 60 nm PR-25 nanofibers with a surface area of about 40 m²/g available from Applied Sciences in Cedarville, Ohio), carbon fiber mesh, 3-D nanostructures (e.g., tree-like structures).

### Fabrication

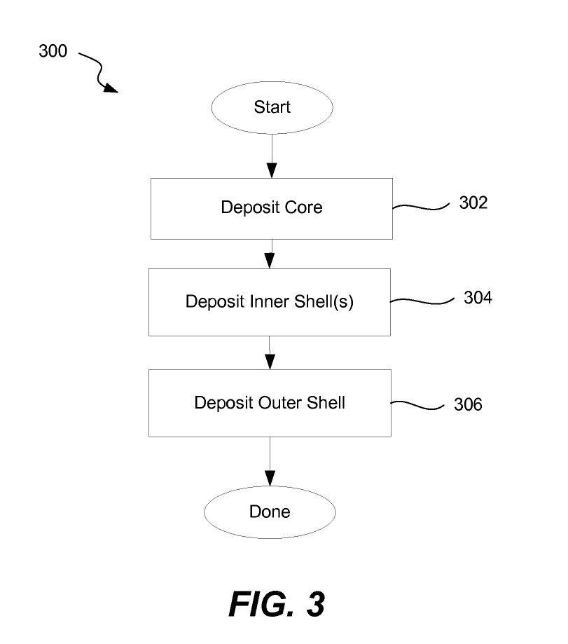

A general process flowchart depicting certain operations of manufacturing nanostructures is presented in FIG. 3. The process 300 may start with deposition of a core (block 302). One example of this operation is electro-spinning followed by annealing or pyrolysis. Electro-spinning polymer examples include: polyamide 6, polyamide 6/12, polyacrylic acid, polyurethane, fluoropolymers, PESO, biopolymers, collagen, and chitosan. Some of these materials are available from Elmarco s.r.o. in the Czech Republic. Selection of polymers and process conditions should allow producing carbon containing cores with the dimensions described above. With certain solvent based electrospinning techniques it may be possible to achieve fibers with a mean diameter as low as about 80 nanometers and possibly lower.

In other embodiments, a core may be formed by oxidation and thermal pyrolysis of polyacrylonitrile (PAN), pitch, or rayon. For example, polyacrylonitrile may be heated to approximately 300° C. in air, which breaks many of the hydrogen bonds and oxidizes the material. The oxidized PAN is then placed into a furnace having an inert atmosphere of a gas such as argon, and heated to approximately 2000° C., which induces graphitization of the material, changing the molecular bond structure. When heated in the correct conditions, these chains bond side-to-side (ladder polymers), forming narrow graphene sheets which eventually merge to form a single, jelly roll-shaped or round filament.

It should be noted that certain operations of forming an electrode, such as bonding a partially or fully manufactured nanostructures to a substrate, may be performed after any of the operations presented in FIG. 3. For example, a core may be bonded to the substrate before depositing inner and outer shells. Further, certain treatment operations, such as introducing a dopant into one or more elements of nanostructures, treatments of partially manufactured nanostructures, may be part of any deposition operations presented in FIG. 3.

The process 300 may then proceed with deposition of the inner shell (block 304). Examples of depositions methods used in this operation include: CVD, PECVD, PVD, and solution based method. For example, in a CVD process a silane may be passed over formed cores at a temperature of between about 300° C. and 700° C. and a pressure of between about 1 Torr and 760 Torr.

Other techniques for producing a core involve vapor-liquid-solid (VLS) or vapor-solid (VS) growth methods, chemical vapor deposition, template-free solution phase methods, including but not limited to solution-liquid-solid (SLS) growth, solvo-thermal, hydrothermal, sol-gel, and supercritical fluid-liquid-solid (SFLS).

In certain embodiments, an inner shell and, possibly, an outer shell may be formed together with a core during electrospinning. For example, a specially designed nozzle may “co-extrude” multiple elements of the nanostructures. In the same or alternative embodiments, certain polymers used in electrospinning may proceed through one or more phase separations forming a fiber.

It should be noted that in certain embodiments operation 304 for depositing an inner shell may be repeated multiple times using different deposition methods and materials in order to form a plurality of inner shells.

The process 300 then continues with deposition of an outer shell (block 306). Example of deposition methods used in this operation include: sugar or carbon based polymer deposition and annealing, carbon-based gas pyrolysis (e.g., using acetylene). For example, carbon containing outer shell may be formed using methane, ethane, or any other suitable carbon containing precursors with or without catalysts. The precursors may be passed over nickel, chromium, molybdenum, or any other suitable catalysts and deposit a carbon layer over the catalyst. Carbon shell nanostructures may be formed by depositing a catalyst onto the surface of partially fabricated nanostructures. Examples of catalyst include gold, aluminum, tin, indium, lead, iron, nickel, titanium, copper, and cobalt. Carbon precursors are then flowed over the catalyzed silicon sub-structures to form a carbon layer. Furthermore, a carbon layer may be deposited by burning a natural gas (a combination of methane and other higher hydrocarbons) over a layer of silicon nanostructures. Other methods include coatings using organic media, which are later baked leaving carbon residue. For example, silicon nanowires may be dipped into a glucose or polymer solution. After allowing the solution to penetrate into the nanowire mesh, it is removed from the solution and baked. Glucose leaves carbon residues on the nanowires.

Outer shells containing oxides, such as titanium oxide, may start with depositing a based material (e.g., titanium) using solution based deposition, atomic layer deposition, or metal plating and then forming oxides of the based materials, for example, by exposing the deposit to oxidants at elevated temperature.

### Electrode and Battery Examples

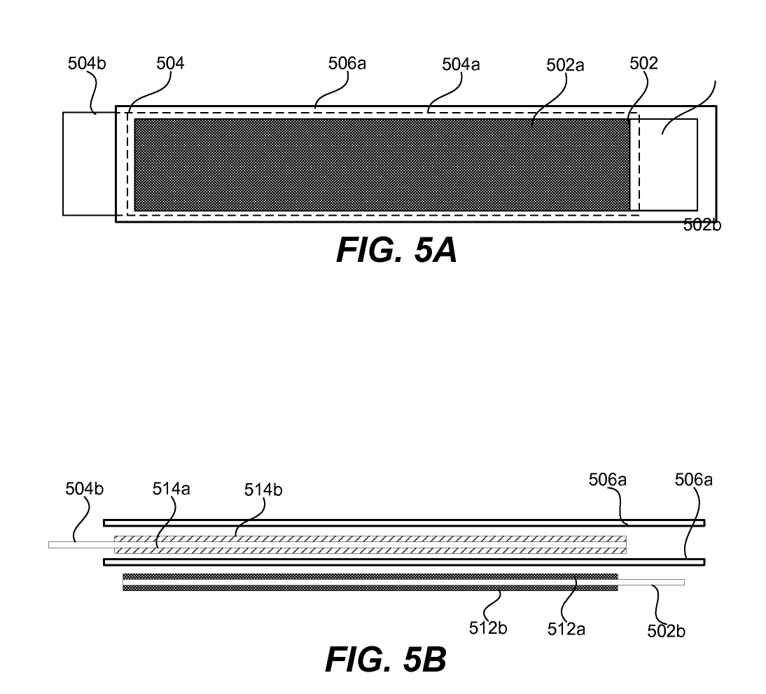

Nanostructures described above can be used to form positive and/or negative battery electrodes. The battery electrodes are then typically assembled into a stack or a jelly roll. FIG. 5A illustrates a side view of an aligned stack including a positive electrode 502, a negative electrode 504, and two sheets of the separator, 506a and 506b in accordance with certain embodiments. The positive electrode 502 may have a positive electrode layer 502a and a positive uncoated substrate portion 502b. Similarly, the negative electrode 504 may have a negative electrode layer 504a and a negative uncoated substrate portion 504b. In many embodiments, the exposed area of the negative electrode layer 504a is slightly larger that the exposed area of the positive electrode layer 502a to ensure trapping of the lithium ions released from the positive electrode layer 502a by insertion material of the negative electrode layer 504a. In one embodiment, the negative electrode layer 504a extends at least between about 0.25 and 5 mm beyond the positive electrode layer 502a in one or more directions (typically all directions). In a more specific embodiment, the negative layer extends beyond the positive layer by between about 1 and 2 mm in one or more directions. In certain embodiments, the edges of the separator sheets 506a and 506b extend beyond the outer edges of at least the negative electrode layer 504a to provide electronic insulation of the electrode from the other battery components. The positive uncoated portion 502b may be used for connecting to the positive terminal and may extend beyond negative electrode 504 and/or the separator sheets 506a and 506b. Likewise, the negative uncoated portion 504b may be used for connecting to the negative terminal and may extend beyond positive electrode 502 and/or the separator sheets 506a and 506b.

FIG. 5B illustrates a top view of the aligned stack. The positive electrode 502 is shown with two positive electrode layers 512a and 512b on opposite sides of the flat positive current collector 502b. Similarly, the negative electrode 504 is shown with two negative electrode layer 514a and 514b on opposite sides of the flat negative current collector. Any gaps between the positive electrode layer 512a, its corresponding separator sheet 506a, and the corresponding negative electrode layer 514a are usually minimal to non-existent, especially after the first cycle of the cell.

The electrodes and the separators are either tightly would together in a jelly roll or are positioned in a stack that is then inserted into a tight case. The electrodes and the separator tend to swell inside the case after the electrolyte is introduced and the first cycles remove any gaps or dry areas as lithium ions cycle the two electrodes and through the separator.

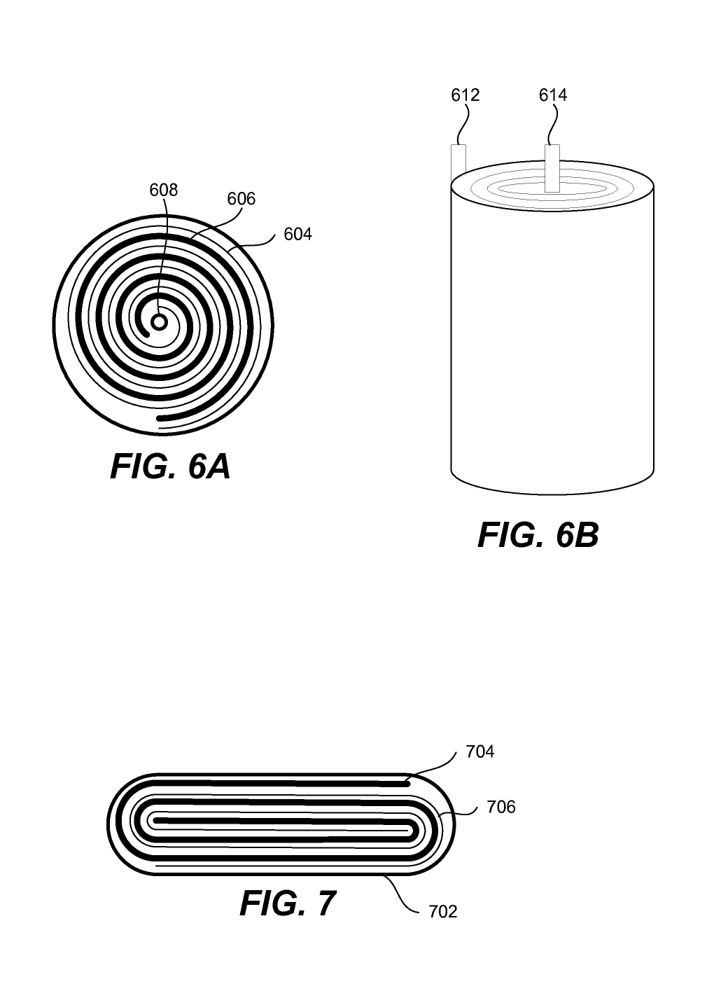

A wound design is a common arrangement. Long and narrow electrodes are wound together with two sheets of separator into a sub-assembly, sometimes referred to as a jellyroll, shaped and sized according to the internal dimensions of a curved, often cylindrical, case. FIG. 6A shows a top view of a jelly roll comprising a positive electrode 606 and a negative electrode 604. The white spaces between the electrodes represent the separator sheets. The jelly roll is inserted into a case 602. In some embodiments, the jellyroll may have a mandrel 608 inserted in the center that establishes an initial winding diameter and prevents the inner winds from occupying the center axial region. The mandrel 608 may be made of conductive material, and, in some embodiments, it may be a part of a cell terminal. FIG. 6B presents a perspective view of the jelly roll with a positive tab 612 and a negative tab 614 extending from the jelly roll. The tabs may be welded to the uncoated portions of the electrode substrates.

The length and width of the electrodes depend on the overall dimensions of the cell and thicknesses of electrode layers and current collector. For example, a conventional 18650 cell with 18 mm diameter and 65 mm length may have electrodes that are between about 300 and 1000 mm long. Shorter electrodes corresponding to low rate/higher capacity applications are thicker and have fewer winds.

A cylindrical design may be desirable for some lithium ion cells because the electrodes swell during cycling and exert pressure on the casing. A round casing may be made sufficiently thin and still maintain sufficient pressure. Prismatic cells may be similarly wound, but their case may bend along the longer sides from the internal pressure. Moreover, the pressure may not be even within different parts of the cells and the corners of the prismatic cell may be left empty. Empty pockets may not be desirable within the lithium ions cells because electrodes tend to be unevenly pushed into these pockets during electrode swelling. Moreover, the electrolyte may aggregate and leave dry areas between the electrodes in the pockets negative effecting lithium ion transport between the electrodes. Nevertheless, for certain applications, such as those dictated by rectangular form factors, prismatic cells are appropriate. In some embodiments, prismatic cells employ stacks rectangular electrodes and separator sheets to avoid some of the difficulties encountered with wound prismatic cells.

FIG. 7 illustrates a top view of a wound prismatic jellyroll. The jelly roll comprises a positive electrode 704 and a negative electrode 706. The white space between the electrodes is representative of the separator sheets. The jelly roll is inserted into a rectangular prismatic case. Unlike cylindrical jellyrolls shown in FIGS. 6A and 6B, the winding of the prismatic jellyroll starts with a flat extended section in the middle of the jelly roll. In one embodiment, the jelly roll may include a mandrel (not shown) in the middle of the jellyroll onto which the electrodes and separator are wound.

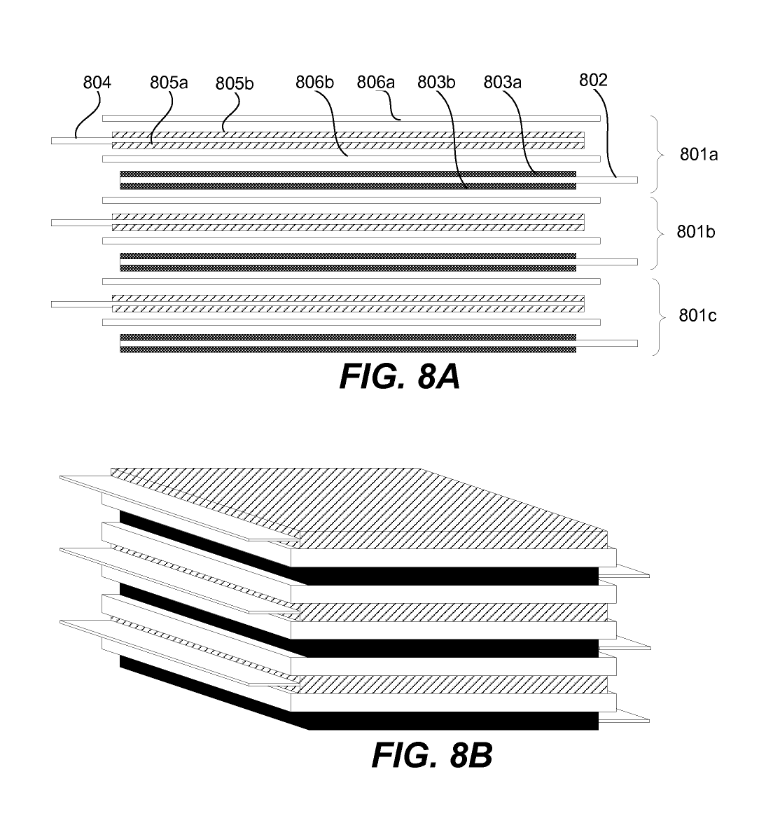

FIG. 8A illustrates a side view of a stacked cell including a plurality of sets (801a, 801b, and 801c) of alternating positive and negative electrodes and a separator in between the electrodes. One advantage of a stacked cell is that its stack can be made to almost any shape, and is particularly suitable for prismatic cells. However, such cell typically requires multiple sets of positive and negative electrodes and a more complicated alignment of the electrodes. The current collector tabs typically extend from each electrode and connected to an overall current collector leading to the cell terminal.

Once the electrodes are arranged as described above, the cell is filled with electrolyte. The electrolyte in lithium ions cells may be liquid, solid, or gel. The lithium ion cells with the solid electrolyte also referred to as a lithium polymer cells.

A typical liquid electrolyte comprises one or more solvents and one or more salts, at least one of which includes lithium. During the first charge cycle (sometimes referred to as a formation cycle), the organic solvent in the electrolyte can partially decompose on the negative electrode surface to form a solid electrolyte interphase layer (SEI layer). The interphase is generally electrically insulating but ionically conductive, allowing lithium ions to pass through. The interphase also prevents decomposition of the electrolyte in the later charging sub-cycles.

Some examples of non-aqueous solvents suitable for some lithium ion cells include the following: cyclic carbonates (e.g., ethylene carbonate (EC), propylene carbonate (PC), butylene carbonate (BC) and vinylethylene carbonate (VEC)), vinylene carbonate (VC), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitrites (e.g., acetonitrile and adiponitrile) linear esters (e.g., methyl propionate, methyl pivalate, butyl pivalate and octyl pivalate), amides (e.g., dimethyl formamide), organic phosphates (e.g., trimethyl phosphate and trioctyl phosphate), and organic compounds containing an S═O group (e.g., dimethyl sulfone and divinyl sulfone), and combinations thereof.

Non-aqueous liquid solvents can be employed in combination. Examples of the combinations include combinations of cyclic carbonate-linear carbonate, cyclic carbonate-lactone, cyclic carbonate-lactone-linear carbonate, cyclic carbonate-linear carbonate-lactone, cyclic carbonate-linear carbonate-ether, and cyclic carbonate-linear carbonate-linear ester. In one embodiment, a cyclic carbonate may be combined with a linear ester. Moreover, a cyclic carbonate may be combined with a lactone and a linear ester. In a specific embodiment, the ratio of a cyclic carbonate to a linear ester is between about 1:9 to 10:0, preferably 2:8 to 7:3, by volume.

A salt for liquid electrolytes may include one or more of the following: LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄(CF₃)₂, LiPF₃(C₂F₅)₃, LiPF₃(CF₃)₃, LiPF₃(iso-C₃F₇)₃, LiPF₅(iso-C₃F₇), lithium salts having cyclic alkyl groups (e.g., (CF₂)₂(SO₂)₂ₓLi and (CF₂)₃(SO₂)₂ₓLi), and combination of thereof. Common combinations include LiPF₆ and LiBF₄, LiPF₆ and LiN(CF₃SO₂)₂, LiBF₄ and LiN(CF₃SO₂)₂.

In one embodiment the total concentration of salt in a liquid nonaqueous solvent (or combination of solvents) is at least about 0.3 M; in a more specific embodiment, the salt concentration is at least about 0.7M. The upper concentration limit may be driven by a solubility limit or may be no greater than about 2.5 M; in a more specific embodiment, no more than about 1.5 M.

A solid electrolyte is typically used without the separator because it serves as the separator itself. It is electrically insulating, ionically conductive, and electrochemically stable. In the solid electrolyte configuration, a lithium containing salt, which could be the same as for the liquid electrolyte cells described above, is employed but rather than being dissolved in an organic solvent, it is held in a solid polymer composite. Examples of solid polymer electrolytes may be ionically conductive polymers prepared from monomers containing atoms having lone pairs of electrons available for the lithium ions of electrolyte salts to attach to and move between during conduction, such as Polyvinylidene fluoride (PVDF) or chloride or copolymer of their derivatives, Poly(chlorotrifluoroethylene), poly(ethylene-chlorotrifluoro-ethylene), or poly(fluorinated ethylene-propylene), Polyethylene oxide (PEO) and oxymethylene linked PEO, PEO-PPO-PEO crosslinked with trifunctional urethane, Poly(bis(methoxy-ethoxy-ethoxide))-phosphazene (MEEP), Triol-type PEO crosslinked with difunctional urethane, Poly((oligo)oxyethylene)methacrylate-co-alkali metal methacrylate, Polyacrylonitrile (PAN), Polymethylmethacrylate (PNMA), Polymethylacrylonitrile (PMAN), Polysiloxanes and their copolymers and derivatives, Acrylate-based polymer, other similar solvent-free polymers, combinations of the foregoing polymers either condensed or cross-linked to form a different polymer, and physical mixtures of any of the foregoing polymers. Other less conductive polymers may be used in combination with the above polymers to improve strength of thin laminates include: polyester (PET), polypropylene (PP), polyethylene napthalate (PEN), polyvinylidene fluoride (PVDF), polycarbonate (PC), polyphenylene sulfide (PPS), and polytetrafluoroethylene (PTFE).

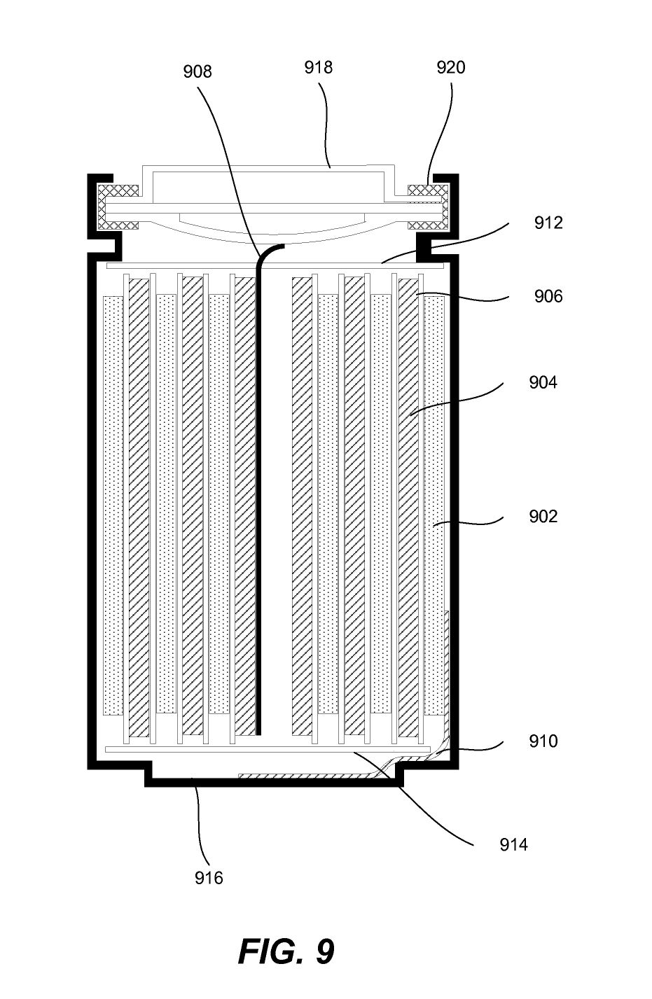

FIG. 9 illustrates a cross-section view of the wound cylindrical cell in accordance with one embodiment. A jelly roll comprises a spirally wound positive electrode 902, a negative electrode 904, and two sheets of the separator 906. The jelly roll is inserted into a cell case 916, and a cap 918 and gasket 920 are used to seal the cell. It should be note that in certain embodiments a cell is not sealed until after subsequent operations (i.e., operation 208). In some cases, cap 912 or case 916 includes a safety device. For example, a safety vent or burst valve may be employed to break open if excessive pressure builds up in the battery. In certain embodiments, a one-way gas release valve is included to release oxygen released during activation of the positive material. Also, a positive thermal coefficient (PTC) device may be incorporated into the conductive pathway of cap 918 to reduce the damage that might result if the cell suffered a short circuit. The external surface of the cap 918 may used as the positive terminal, while the external surface of the cell case 916 may serve as the negative terminal. In an alternative embodiment, the polarity of the battery is reversed and the external surface of the cap 918 is used as the negative terminal, while the external surface of the cell case 916 serves as the positive terminal. Tabs 908 and 910 may be used to establish a connection between the positive and negative electrodes and the corresponding terminals. Appropriate insulating gaskets 914 and 912 may be inserted to prevent the possibility of internal shorting. For example, a Kapton™ film may used for internal insulation. During fabrication, the cap 918 may be crimped to the case 916 in order to seal the cell. However prior to this operation, electrolyte (not shown) is added to fill the porous spaces of the jelly roll.

A rigid case is typically required for lithium ion cells, while lithium polymer cells may be packed into a flexible, foil-type (polymer laminate) case. A variety of materials can be chosen for the case. For lithium-ion batteries, Ti-6-4, other Ti alloys, Al, Al alloys, and 300 series stainless steels may be suitable for the positive conductive case portions and end caps, and commercially pure Ti, Ti alloys, Cu, Al, Al alloys, Ni, Pb, and stainless steels may be suitable for the negative conductive case portions and end caps.

In addition to the battery applications described above, metal silicides may be used in fuel cells (e.g., for negative electrodes, positive electrodes, and electrolytes), hetero junction solar cell active materials, various forms of current collectors, and/or absorption coatings. Some of these applications can benefit from a high surface area provided by metal silicide structures, high conductivity of silicide materials, and fast inexpensive deposition techniques.

### CONCLUSION

Although the foregoing invention has been described in some detail for purposes of clarity of understanding, it will be apparent that certain changes and modifications may be practiced within the scope of the appended claims. It should be noted that there are many alternative ways of implementing the processes, systems, and apparatus of the present invention. Accordingly, the present embodiments are to be considered as illustrative and not restrictive, and the invention is not to be limited to the details given herein.

What is claimed is:

1. A nanostructure for use in a battery electrode, the nanostructure comprising:
a conductive core for providing electronic conductivity along the length of the nanostructure;
an inner shell including a high capacity electrochemically active material having a stable electrochemical capacity of at least about 1000 mAh/g, said inner shell in electronic communication with the conductive core; and
an outer shell partially coating the inner shell and substantially preventing formation of a Solid Electrolyte Interphase (SEI) layer directly on the inner shell.

2. The nanostructure of claim 1, wherein the high capacity electrochemically active material comprises one or more materials selected from the group consisting of silicon, germanium, and tin.

3. The nanostructure of claim 1, wherein the high capacity electrochemically active material comprises amorphous silicon, and wherein conductive core and the outer shell comprise carbon.

4. The nanostructure of claim 1, wherein the high capacity electrochemically active material comprises one or more dopants.

5. The nanostructure of claim 1, wherein the outer shell comprises one or more materials selected from the group consisting of graphite, graphene, graphite oxide, and metal oxide.

6. The nanostructure of claim 1, wherein the conductive core comprises a carbon containing material with a carbon content of at least about 50%.

7. The nanostructure of claim 1, wherein the inner shell provides at least about 50% of the overall electrochemical capacity of the nanostructure.

8. The nanostructure of claim 1, wherein the nanostructure is a nanowire having a length of at least about 1 millimeter.

9. The nanostructure of claim 1, wherein the diameter of the nanostructure is no greater than about 500 nanometers.

10. The nanostructure of claim 1, wherein the nanostructure is a nanoparticle.

11. The nanostructure of claim 1, wherein the thickness of the outer shell is between about 1 nanometer and 100 nanometers.

12. The nanostructure of claim 1, wherein the conductive core is hollow.

13. The nanostructure of claim 12, wherein the conductive core comprises a carbon single wall nanotube (SWNT) or a carbon multi-wall nanotube (MWNT).

14. The nanostructure of claim 12, wherein an average ratio of the void region of the nanostructure to the solid region of the nanostructure is between about 0.01 and 10.

15. The nanostructure of claim 1, wherein at least about 10% of the inner shell is not coated with the outer shell.

16. The nanostructure of claim 1, wherein the nanostructure has a branched structure.

17. The nanostructure of claim 1, further comprising a third shell disposed between the inner shell and the outer shell.

18. A battery electrode for use in an electrochemical battery, the battery electrode comprising:
a conductive substrate; and
a nanostructure comprising:
a conductive core for providing electronic conductivity along the length of the nanostructure;
an inner shell including a high capacity electrochemically active material having a capacity of at least about 1000 mAh/g and in electronic communication with the conductive core; and
an outer shell partially coating the inner shell and substantially preventing formation of a Solid Electrolyte Interphase (SEI) directly on the inner shell,
wherein at least the conductive core and the inner shell are in electronic communication with the conductive substrate.

19. The battery electrode of claim 18, wherein the conductive core, the inner shell, and/or the outer shell of the nanostructure form a direct bond with the conductive substrate.

20. The battery electrode of claim 19, wherein the direct bond with the conductive substrate comprises a silicide.

21. The battery electrode of claim 18, wherein the outer shell comprises a carbon layer that extends over at least a portion of a nanostructure-facing surface of the conductive substrate and forms a direct bond between the nanostructure and the conductive substrate.

22. The battery electrode of claim 18, further comprising an elastomeric binder.

23. A method of forming a nanostructure for use in a battery electrode, the method comprising:
forming a conductive core for providing electronic conductivity along the length of the nanostructure;
forming an inner shell including a high capacity electrochemically active material having a stable electrochemical capacity of at least about 1000 mAh/g and in electronic communication with the conductive core; and
forming an outer shell partially coating the inner shell and substantially preventing formation of a Solid Electrolyte Interphase (SEI) directly on the inner shell.

24. The method of claim 23, wherein the conductive core is formed by electrospinning.

25. The method of claim 23, wherein the outer shell is formed after placing a partially fabricated nanostructure comprising the conductive core and the inner shell in contact with a conductive substrate.

26. The method of claim 25, wherein forming the outer shell establishes a bond between the nanostructure and the conductive substrate.

27. The method of claim 23, further comprising bonding the nanostructure to a conductive substrate.

28. The method of claim 27, wherein bonding comprises heating the nanostructure and the conductive substrate to a predetermined temperature and applying a predetermined pressure between the nanostructure and the conductive substrate.

29. The method of claim 28, wherein the inner shell comprises silicon, and wherein the predetermined temperature is between about 300° C. and 500° C.

30. The method of claim 27, wherein bonding comprises forming a silicide on the nanostructure and pressing the nanostructure containing the silicide against the conductive substrate to form chemical bonds between the silicide and the conductive substrate.
